(19) United States
(12) Patent Application Publication
(10) Pub. No.: US 2003/0157218 A1
(43) Pub. Date: Aug. 21, 2003

(54) Product and process of making a protein, vitamin, mineral and antioxidant fortified sport beer

(76) Inventor: Erik Thurman Donhowe, Castle Rock, CO (US)

Correspondence Address: Erik T. Donhowe, Suite 243, 200 South Wilcox Street, Castle Rock, CO, 80104, US

(21) Appl. No.: 10/078,207

(22) Filed: Feb. 20, 2002

(51) Int. Cl. C12C 11/00

(52) U.S. Cl. 426/16

(57) ABSTRACT

A process is provided for the preparation of a sport beer or malt beverage that has enhanced nutrition in comparison to existing beer or malt beverages. The beverage comprises a beer or malt beverage that contains supplemental protein, peptide, amino acid, antioxidant, mineral and/or vitamin supplements. Such a beverage provides a healthier alternative to conventional beer or malt beverages, especially when consumed in post recreational sport social contexts.

### CROSS-REFERENCE TO RELATED APPLICATIONS

Not Applicable

### FEDERALLY SPONSORED RESEARCH OR DEVELOPMENT

Not Applicable

### MICROFICHE APPENDIX

Not Applicable

### BACKGROUND OF THE INVENTION

This invention relates to a new beer formulation and to a method of producing the same. Intensive energy-consuming sport activities such as golf, skiing, tennis, fitness workouts, baseball, football and general athletics are increasingly becoming popular as adult recreational activities. The context in which these activities occur commonly includes post-recreational social gatherings, during which alcoholic beverages such as beer are often consumed. Hitherto, beer and malt beverages consumed at these events have been limited in nutritional needs associated with recreational activities; beer and malt beverages are typically low in contents of protein, minerals, antioxidants and vitamins. Beer typically contains 13 g of carbohydrates, 1 g of protein, and no vitamin A or vitamin C per 12 fluid ounce servings.

Protein supplementation aids anabolic metabolism, as protein is a key nutritional component required for building muscles. Intensive recreational activities stimulate the need to rebuild and strengthen muscle fibers; hence protein supplementation is helpful to supply protein and amino acid needs following the recreational activities.

Vitamin supplementation to beverages aids energy metabolism, as vitamins are primary cofactors used in electron transfer steps in anabolic and catabolic metabolism. Vitamins such as vitamin C and vitamin E also function as antioxidants.

In outdoor recreational activities, ultraviolet light exposure can result in the production of free radicals in the body. Additionally, high aerobic respiration during these activities results in high oxygen levels and resultant free radical formation. Free radical formation leads to radical chain reactions and catabolism of protein and other tissues in the body, and it also contributes to physical exhaustion and potentially even carcinogenesis. Antioxidants serve to react with free radicals, terminating such deleterious radical chain reactions.

The present invention describes a beer/malt beverage that contains protein supplementation, vitamin supplementation, mineral supplementation and antioxidants

U.S. Pat. No. 5,415,885 issued to the Sweetenbetter Company describes a malt-based soft drink with enhanced nutritional value due to reduced levels of sweet sugars (sucrose, invert syrup, high fructose corn syrup). The patent does not describe protein, vitamin, mineral or antioxidant fortification,

U.S. Pat. No. 3,949,098 issued to Nabisco, Inc. describes a protein-fortified orange juice beverage. The patent does not describe vitamin, mineral or antioxidant fortification, and the application is not for a beer or malt beverage.

U.S. Pat. No. 4,073,947 issued to the Grain Processing Corporation describes the addition of a protein hydrolyzate, ammonium ions and potassium phosphate to a hydrolyzed starch mixture, followed by yeast fermentation, to produce a beer-type alcoholic beverage. The patent does not describe vitamin, mineral or antioxidant fortification. Furthermore, the supplemental protein hydrolyzate is a metabolite consumed during yeast fermentation as part of the process designed to enhance yeast fermentation.

U.S. Pat. No. 4,880,643 issued to Bass Public Limited Company describes the addition of protein or protein fragments to beer. The object to the patent is to improve the foam head of the beer product, not to improve nutritional value of the product. Additionally, the protein added is egg albumin only, and it is added at relatively low levels (0.1 to 1.0 mg per ml of beer). The patent does not describe vitamin, mineral or antioxidant fortification.

None of the prior art described a beer/malt beverage with vitamin, antioxidant, minerals and/or protein or amino acid supplementation. This present invention satisfies the need for a post-recreational beer/malt beverage that provides these needed nutrients.

### BRIEF SUMMARY OF THE INVENTION

This invention describes a new, improved sport beer and a process for the preparation of the same. The sport beer of the invention has the flavor, color and appearance of beer/malt beverages consumed during post recreational social settings, but contains substantially improved nutritional value. Typical beer beverages consumed during these settings are carbohydrate rich with low contents of protein, minerals, antioxidants and vitamins. The sport drink of this invention has nutritionally beneficial supplements to provide higher levels of protein and peptides, minerals, antioxidants and vitamins.

The process described in this invention comprises a brewing process wherein barley malt grain is mashed in water, cereal grain adjuncts may or may not be added, amylase-type enzymes may or may not be added, the mash is clarified and boiled in a brew kettle, hops are added during the brew kettle boil or subsequently in the process, the extract or wort is clarified, cooled and aerated, yeast is added, yeast fermentation occurs, yeast is removed by filtration and centrifugation, beer aging and conditioning occurs, and protein supplements, vitamin supplements, calcium, zinc and/or iron, and natural antioxidants are added.

### DETAILED DESCRIPTION OF THE INVENTION

The beverage described in this invention is composed of 92% to 99.5% water by volume, 0.45% to 8% ethyl alcohol by volume, 3.3 to 50 grams/liter protein/branched chain amino acids, 3.3 to 50 grams/liter protein, 3.3 to 50 grams/liter minerals (iron, calcium and zinc), 0.01 mg/liter to 1 grams/liter antioxidants (Vitamin C, Vitamin E and selenium), and 10% to 100% of the U.S. Recommended Daily Value of vitamins (Vitamin A, Vitamin E, Vitamin C, Vitamin B1, Vitamin B2, Vitamin B6, and Vitamin B12).

The process for the production of the sport beer described in this invention consists of a brewing process wherein barley malt grain is milled, mixed with hot water, cooked to convert complex carbohydrates into soluble fermentable sugars, the resultant mash is clarified and transferred to a brew kettle where it is boiled and, hops are added. The resultant extract or wort is clarified, cooled to 7 to 15 degrees C. and aerated, yeast is added, and yeast fermentation occurs for 3 to 10 days. Yeast is removed by settling, filtration and/or centrifugation, and beer lagering or maturation occurs. The beer is transferred to a finishing tank, where protein supplements, vitamin supplements, calcium, zinc and/or iron, and natural antioxidants are added, followed by carbonation. The protein, mineral, vitamin and antioxidant supplements are dissolved in filtered water prior to addition to the beer. Carbonation is conducted with 2 to 3 volumes of CO2 per volume of beer. Finally, the sport beer is pasteurized or sterile filtered and packaged into bottles, cans or kegs.

In one embodiment of the invention, an all-malt beer/malt beverage is produced. In another embodiment of the invention, cereal grain adjuncts are cooked in water and added to the brew kettle, providing a different flavor and body than an all-malt sport beer. In yet another embodiment of the invention, additional starch debranching enzymes such as amyloglucosidase or limit dextrinase (pullulanase) are added to the mash to increase to conversion of carbohydrates to fermentable sugars, providing a low calorie sport beer product. Such starch debranching enzymes are commercially available from sources such as Novo Nordisk Bioindistries (Danbury, Conn.).

This invention is further demonstrated by the following illustrative examples.

### EXAMPLE 1

composition:

266 liters filtered water

70 kg of pale malt

20 kg of Munich malt

10 kg of crystal malt

1.5 kg bittering pellet hops

2 kg aroma pellet hops

Hydrolyzed proteins and branched chain amino acids, 236 g

Vitamin mixture, liquid concentrate, add to achieve 25% RDA in 0.355 liters concentration

Add the malt to 180 liters of 70 degree C. water and steep for 90 minutes at 67 degrees C. Sparge with 60 liters of 67 degrees C. water, transferring the entire mash to the brew kettle. Bring the extract in the brew kettle to a boil. Add the bittering hops. Boil for 45 minutes and add the aroma hops. Boil 15 minutes, cool and clarify the wort by using a settling tank or whirlpool tank. Aerate the wort while cooling to 20 degrees C. and transfer it to the fermentation tank. Pitch the wort with ale yeast, and ferment for 3 to 7 days. Transfer the beer to the maturation tank and mature the beer at 8 to 10 degrees C. for 3 to 4 weeks. Transfer the beer to the finishing tank; add 26 liters containing the protein and vitamin supplement. Filter the beer through a plate and frame sheet filter and package into bottles, cans or kegs

The beverage has a 5% by volume alcohol content, providing a protein content of 3.5 gram per 12 fluid ounces and vitamins at 25% of the RDA values in a 12 oz serving.

### EXAMPLE II

composition:

266 liters filtered water

10 kg of crystal malt

50 kg of pale malt

35 kg of corn grits

2 kg bittering pellet hops

0.5 kg aroma pellet hops

Hydrolyzed proteins and branched chain amino acids, 236 g

Ascorbic acid, 236 g

Vitamin mixture, liquid concentrate, add to achieve 25% RDA in 0.355 liters concentration

Add the malt to 180 liters of 65 degree C. water and steep for 60 minutes at 60 degrees C. Raise the temperature to 68 degrees C. and steep for 30 minutes. Sparge with 60 liters of 67 degrees C. water, transferring the entire mash to the brew kettle. Bring the extract in the brew kettle to a boil. Add the bittering hops. Boil for 45 minutes and add the aroma hops. Boil 15 minutes, cool and clarify the wort by using a settling tank or whirlpool tank. Aerate the wort while cooling to 20 degrees C. and transfer it to the fermentation tank. Pitch the wort with lager yeast, and ferment for 3 to 7 days. Transfer the beer to the maturation tank and mature the beer at 2 to 8 degrees C. for 3 to 4 weeks. Transfer the beer to the finishing tank; add 26 liters containing the protein and vitamin supplement. Filter the beer through a plate and frame sheet filter and package into bottles, cans or kegs

The beverage has a 4.5% by volume alcohol content, providing an antioxidant content of 0.1 grams per liter, calcium at 20% of the RDA values and vitamins at 25% of the RDA values in a 12 oz serving.

### EXAMPLE III

composition:

266 liters filtered water

10 kg of crystal malt

30 kg of pale malt

15 kg of rice solids

25 kg of corn grits

2 kg bittering pellet hops

0.5 kg aroma pellet hops

Ascorbic acid, 236 g

Calcium citrate, 1.86 kg

Vitamin mixture, liquid concentrate, add to achieve 25% RDA in 0.355 liters concentration

Add the malt to 180 liters of 65 degree C. water and steep for 450 minutes at 60 degrees C. Raise the temperature to 68 degrees C., add limit dextrinase or amyloglucosidase, and steep for 30 minutes. Sparge with 60 liters of 67 degrees C. water, transferring the entire mash to the brew kettle. Bring the extract in the brew kettle to a boil. Add the bittering hops. Boil for 45 minutes and add the aroma hops. Boil 15 minutes, cool and clarify the wort by using a settling tank or whirlpool tank. Aerate the wort while cooling to 20 degrees C. and transfer it to the fermentation tank. Pitch the wort with lager yeast, and ferment for 3 to 7 days. Transfer the beer to the maturation tank and mature the beer at 2 to 8 degrees C. for 3 to 4 weeks. Transfer the beer to the finishing tank; add 26 liters containing the protein and vitamin supplement. Filter the beer through a plate and frame sheet filter and package into bottles, cans or kegs The beverage has a 4.5% by volume alcohol content, providing an antioxidant content of 0.1 grams per liter, calcium at 20% of the RDA values and vitamins at 25% of the RDA values in a 12 oz serving.

I claim:

1. A beer or malt beverage containing protein supplementation, vitamin supplementation, mineral supplementation and antioxidants.

2. A beverage according to claim 1, wherein the beverage contains between 0.45% and 10% alcohol by volume.

3. A beverage according to claim 1, wherein the beverage is fortified with highly nutritious and highly bioavailable supplemental protein added in final concentrations in the beverage from 0.33% to 5% by weight.

4. A beverage according to claim 3, wherein the supplemental protein consists of whey, casein, soy protein, rice protein, albumin, hydrolyzed protein, and/or highly branched chain amino acids (BCAAs).
